(19) United States
(12) Patent Application Publication
(10) Pub. No.: US 2023/0075672 A1
(43) Pub. Date: Mar. 9, 2023

(54) TRAVEL ROAD DETERMINATION APPARATUS AND TRAVEL ROAD DETERMINATION METHOD

(71) Applicant: Mitsubishi Electric Corporation, Tokyo (JP)

(72) Inventors: Masatoshi FUJII, Tokyo (JP); Mitsuo SHIMOTANI, Tokyo (JP); Kentaro DAIKOKU, Tokyo (JP); Keisuke INOUE, Tokyo (JP)

(73) Assignee: Mitsubishi Electric Corporation, Tokyo (JP)

(21) Appl. No.: 17/793,500

(22) PCT Filed: Mar. 18, 2020
(86) PCT No.: PCT/JP2020/011879

§ 371 Date: Jul. 18, 2022

(51) Int. Cl. B60W 40/076; B60W 60/00

(52) U.S. Cl. CPC B60W 40/076; B60W 60/00; B60W 2556/45; B60W 2556/40; B60W 2556/10

(57) ABSTRACT

A travel road determination apparatus includes a vehicle position acquisition unit and a travel road determination unit. The vehicle position acquisition unit acquires position information of a vehicle. In first determination processing, the travel road determination unit determines whether or not the vehicle that is determined to be traveling on a first-type road based on first position information of the vehicle has started traveling on a second-type road, based on second position information of the vehicle and first map data. In second determination processing, the travel road determination unit determines whether or not the vehicle that is determined to be traveling on the second-type road based on third position information of the vehicle has started traveling on the first-type road, based on fourth position information of the vehicle and the second map data.

### TECHNICAL FIELD

The present disclosure relates to a travel road determination apparatus and a travel road determination method.

### BACKGROUND ART

A drive assistance device of a vehicle performs drive assistance of the vehicle, based on high accuracy map information and position information of the vehicle. The high accuracy map information includes data of a road shape of each traffic lane. For example, Patent Document 1 proposes a technology of performing search of a route and generation of guide information, using both of a road map based on a road reference line and a road map based on a traffic lane reference line.

### PRIOR ART DOCUMENTS

### Patent Documents

Patent Document 1: Japanese Patent Application Laid-Open No. 2006-266865

### SUMMARY

### Problem to be Solved by the Invention

When the drive assistance device performs drive assistance of the vehicle, it is necessary to perform determination as to whether the vehicle is traveling on a road (advanced drive assistance road) having a road shape represented by high accuracy map information or is traveling on a road having a road shape represented by regular accuracy map information. In particular, accurately determining the timing at which the road on which the vehicle travels switches from the advanced drive assistance road to the general road or the timing at which the road switches from the general road to the advanced drive assistance road is necessary for implementation of accurate drive assistance.

The present disclosure is made in order to solve the problem described above, and has an object to provide a travel road determination apparatus that accurately determines a road type of a road on which a vehicle is traveling in a connection area between a road represented by a map including road information of each traffic lane and a road represented by a map including road information of each road.

### Means to Solve the Problem

A travel road determination apparatus according to the present disclosure includes a vehicle position acquisition unit and a travel road determination unit. The vehicle position acquisition unit acquires position information of a vehicle. The travel road determination unit performs first determination processing and second determination processing. In the first determination processing, the travel road determination unit determines whether or not the vehicle that is determined to be traveling on a first-type road based on first position information of the vehicle has started traveling on a second-type road, based on second position information of the vehicle and first map data. The first-type road is a road having a road shape represented by the first map data including road shape data of each traffic lane. The second-type road is a road having a road shape represented by second map data including road shape data of each road. In the second determination processing, the travel road determination unit determines whether or not the vehicle that is determined to be traveling on the second-type road based on third position information of the vehicle has started traveling on the first-type road, based on fourth position information of the vehicle and the second map data.

### Effects of the Invention

According to the present disclosure, a travel road determination apparatus that accurately determines a road type of a road on which a vehicle is traveling in a connection area between a road represented by a map including road information of each traffic lane and a road represented by a map including road information of each road can be provided.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a functional block diagram illustrating a configuration of a travel road determination apparatus according to the first embodiment.

FIG. 2 is a diagram illustrating an example of a configuration of a processing circuit included in the travel road determination apparatus.

FIG. 3 is a diagram illustrating another example of a configuration of a processing circuit included in the travel road determination apparatus.

FIG. 4 is a flowchart illustrating a travel road determination method including first determination processing according to the first embodiment.

FIG. 5 is a flowchart illustrating the travel road determination method including second determination processing according to the first embodiment.

FIG. 6 is a functional block diagram illustrating a configuration of a travel road determination apparatus and a drive assistance device according to the second embodiment.

FIG. 7 is a diagram illustrating an example of a relationship between road types and pieces of map data according to the second embodiment.

FIG. 8 is a flowchart illustrating a travel road determination method according to the second embodiment.

FIG. 9 is a flowchart illustrating determination processing regarding a regular road according to the second embodiment.

FIG. 10 is a flowchart illustrating determination processing regarding a connection road according to the second embodiment.

FIG. 11 is a flowchart illustrating determination processing regarding a freeway according to the second embodiment.

FIG. 12 is a diagram illustrating an example of road information based on regular accuracy map data around a gate of the freeway.

FIG. 13 is a diagram illustrating an example of road information based on high accuracy map data around the gate of the freeway.

FIG. 14 is a diagram illustrating another example of road information based on the high accuracy map data around the gate of the freeway.

FIG. 15 is a diagram illustrating another example of road information based on the regular accuracy map data around the gate of the freeway.

FIG. 16 is a diagram illustrating an example of a relationship between road types and pieces of map data according to the third modification of the second embodiment.

FIG. 17 is a diagram illustrating an example of a relationship between road types and pieces of map data according to the fourth modification of the second embodiment.

FIG. 18 is a functional block diagram illustrating a configuration of a travel road determination apparatus and a drive assistance device according to the sixth embodiment.

FIG. 19 is a block diagram illustrating a configuration of a travel road determination apparatus and devices operating in association therewith according to the seventh embodiment.

### DESCRIPTION OF EMBODIMENTS

### First Embodiment

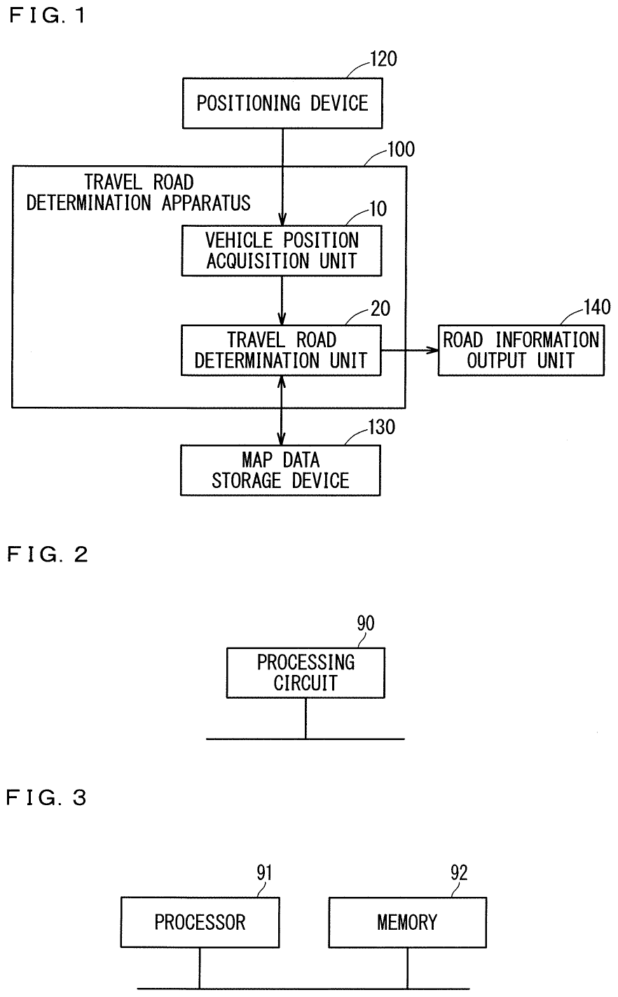

FIG. 1 is a functional block diagram illustrating a configuration of a travel road determination apparatus 100 according to the first embodiment.

The travel road determination apparatus 100 includes a vehicle position acquisition unit 10 and a travel road determination unit 20. A map data storage device 130 stores first map data and second map data. The first map data includes road shape data of each traffic lane. The second map data includes road shape data of each road. A positioning device 120 measures a travel position of a vehicle.

The vehicle position acquisition unit 10 acquires position information of a vehicle. Here, the vehicle position acquisition unit 10 acquires first position information, second position information, third position information, and fourth position information from the positioning device 120. The first position information to the fourth position information include information of travel positions of a vehicle that are different from one another. The travel position of the vehicle in the second position information corresponds to a position ahead of the travel position of the vehicle in the first position information in a traveling direction of the vehicle. The travel position of the vehicle in the fourth position information corresponds to a position ahead of the travel position of the vehicle in the third position information in a traveling direction of the vehicle. In other words, the vehicle position acquisition unit 10 acquires the first position information to the fourth position information at different timings during traveling of the vehicle.

The travel road determination unit 20 performs first determination processing and second determination processing. In the first determination processing, the travel road determination unit 20 determines whether or not a vehicle that is determined to be traveling on a first-type road based on the first position information of the vehicle has started traveling on a second-type road, based on the second position information of the vehicle and the first map data. The first-type road is a road having a road shape represented by the first map data. The second-type road is a road having a road shape represented by the second map data. The travel road determination unit 20 outputs determination results to a road information output unit 140.

In the second determination processing, the travel road determination unit 20 determines whether or not the vehicle that is determined to be traveling on the second-type road based on the third position information of the vehicle has started traveling on the first-type road, based on the fourth position information of the vehicle and the second map data. The travel road determination unit 20 outputs determination results to the road information output unit 140.

The order of execution of the first determination processing and the second determination processing is not fixed. For example, the travel road determination unit 20 executes the second determination processing after the first determination processing. Alternatively, the travel road determination unit 20 executes the first determination processing after the second determination processing.

The road information output unit 140 outputs the first map data to advanced driver-assistance systems (ADAS), for example, based on the determination results indicating that the vehicle is traveling on the first-type road.

FIG. 2 is a diagram illustrating an example of a configuration of a processing circuit 90 included in the travel road determination apparatus 100. Each function of the vehicle position acquisition unit 10 and the travel road determination unit 20 is implemented by the processing circuit 90. In other words, the processing circuit 90 includes the vehicle position acquisition unit 10 and the travel road determination unit 20.

When the processing circuit 90 is dedicated hardware, the processing circuit 90 is, for example, a single circuit, a composite circuit, a programmed processor, a parallel programmed processor, an application specific integrated circuit (ASIC), a field-programmable gate array (FPGA), a circuit combining these, or the like. Each function of the vehicle position acquisition unit 10 and the travel road determination unit 20 may be individually implemented by a plurality of processing circuits, or may be collectively implemented by a single processing circuit.

FIG. 3 is a diagram illustrating another example of a configuration of a processing circuit included in the travel road determination apparatus 100. The processing circuit includes a processor 91 and a memory 92. When the processor 91 executes a program stored in the memory 92, each function of the vehicle position acquisition unit 10 and the travel road determination unit 20 is implemented. For example, when software or firmware described as a program is executed by the processor 91, each function is implemented. In this manner, the travel road determination apparatus 100 includes the memory 92 that stores a program, and the processor 91 that executes the program.

The program describes a function that the travel road determination apparatus 100 acquires the position information of a vehicle, and performs the first determination processing and the second determination processing. The program describes a function of determining, in the first determination processing, whether or not a vehicle that is determined to be traveling on the first-type road based on the first position information of the vehicle has started traveling on the second-type road, based on the second position information of the vehicle and the first map data. Further, the program describes a function of determining, in the second determination processing, whether or not the vehicle that is determined to be traveling on the second-type road based on the third position information of the vehicle has started traveling on the first-type road, based on the fourth position information of the vehicle and the second map data. In this manner, the program causes a computer to execute a procedure or a method of the vehicle position acquisition unit 10 and the travel road determination unit 20.

The processor 91 is, for example, a central processing unit (CPU), an arithmetic device, a microprocessor, a microcomputer, a digital signal processor (DSP), or the like. The memory 92 is, for example, a non-volatile or volatile semiconductor memory, such as a random access memory (RAM), a read only memory (ROM), a flash memory, an erasable programmable read only memory (EPROM), and an electrically erasable programmable read only memory (EEPROM). Alternatively, the memory 92 may be any storage medium to be used in the future, such as a magnetic disk, a flexible disk, an optical disc, a compact disc, a MiniDisc, and a DVD.

A part of each function of the vehicle position acquisition unit 10 and the travel road determination unit 20 described above may be implemented by dedicated hardware, and another part thereof may be implemented by software or firmware. In this manner, the processing circuit implements each function described above by hardware, software, firmware, or a combination of these.

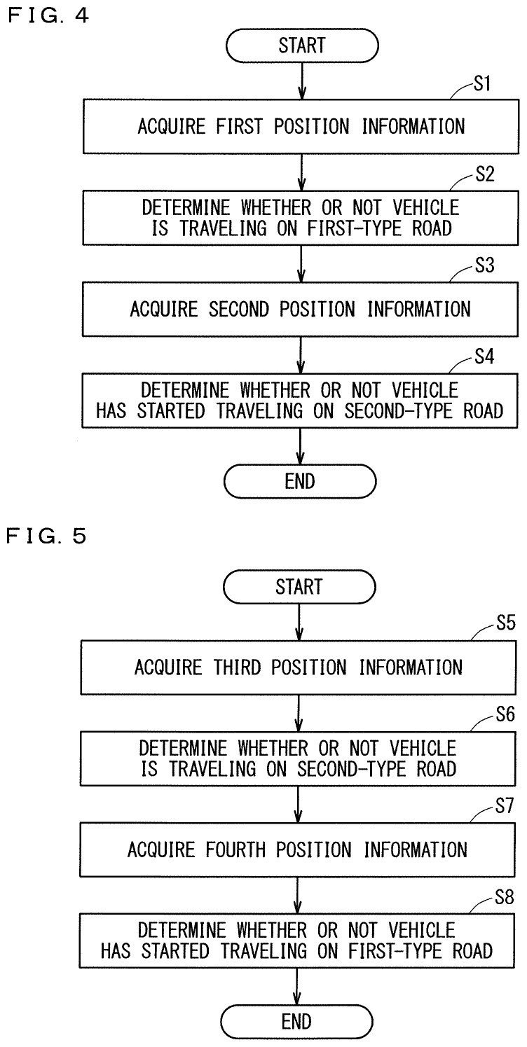

FIG. 4 is a flowchart illustrating a travel road determination method including the first determination processing according to the first embodiment.

In Step S1, the vehicle position acquisition unit 10 acquires the first position information of a vehicle.

In Step S2, the travel road determination unit 20 determines whether or not the vehicle is traveling on the first-type road, based on the first position information. Here, the vehicle is determined to be traveling on the first-type road.

In Step S3, the vehicle position acquisition unit 10 acquires the second position information of the vehicle. The travel road determination unit 20 acquires, from the map data storage device 130, the first map data representing the first-type road around the travel position of the vehicle corresponding to the second position information.

In Step S4, the travel road determination unit 20 determines whether or not the vehicle has started traveling on the second-type road, based on the second position information and the first map data. The travel road determination unit 20 outputs determination results to the road information output unit 140.

FIG. 5 is a flowchart in the travel road determination method including the second determination processing according to the first embodiment.

In Step S5, the vehicle position acquisition unit 10 acquires the third position information of the vehicle.

In Step S6, the travel road determination unit 20 determines whether or not the vehicle is traveling on the second-type road, based on the third position information. Here, the vehicle is determined to be traveling on the second-type road.

In Step S7, the vehicle position acquisition unit 10 acquires the fourth position information of the vehicle. The travel road determination unit 20 acquires, from the map data storage device 130, the second map data representing the second-type road around the travel position of the vehicle corresponding to the fourth position information.

In Step S8, the travel road determination unit 20 determines whether or not the vehicle has started traveling on the first-type road, based on the fourth position information and the second map data. The travel road determination unit 20 outputs determination results to the road information output unit 140.

The order of execution of the determination method illustrated in FIG. 4 and the determination method illustrated in FIG. 5 is not fixed. For example, Steps S5 to S8 are executed after Steps S1 to S4. Alternatively, for example, Steps S1 to S4 are executed after Steps S5 to S8.

The description above is summarized as follows. The travel road determination apparatus 100 according to the first embodiment includes the vehicle position acquisition unit 10 and the travel road determination unit 20. The vehicle position acquisition unit 10 acquires the position information of a vehicle. The travel road determination unit 20 performs the first determination processing and the second determination processing. In the first determination processing, the travel road determination unit 20 determines whether or not the vehicle that is determined to be traveling on the first-type road based on the first position information of the vehicle has started traveling on the second-type road, based on the second position information of the vehicle and the first map data. The first-type road is a road having a road shape represented by the first map data including the road shape data of each traffic lane. The second-type road is a road having a road shape represented by the second map data including the road shape data of each road. In the second determination processing, the travel road determination unit 20 determines whether or not the vehicle that is determined to be traveling on the second-type road based on the third position information of the vehicle has started traveling on the first-type road, based on the fourth position information of the vehicle and the second map data.

The travel road determination apparatus 100 as described above accurately determines a road type of the road on which the vehicle is traveling in a connection area between the first-type road represented by the first map data including the road information of each traffic lane and the second-type road represented by the second map data including the road information of each road.

Further, in the travel road determination method according to the first embodiment, the position information of a vehicle is acquired. In the travel road determination method, when the vehicle is determined to be traveling on the first-type road having a road shape represented by the first map data including the road shape data of each traffic lane based on the first position information of the vehicle, the first determination processing is performed. In the first determination processing, in the travel road determination method, whether or not the vehicle has started traveling on the second-type road having a road shape represented by the second map data including the road shape data of each road is determined based on the second position information of the vehicle and the first map data. Further, in the travel road determination method, when the vehicle is determined to be traveling on the second-type road based on the third position information of the vehicle, the second determination processing is performed. In the second determination processing, in the travel road determination method, whether or not the vehicle has started traveling on the first-type road is determined based on the fourth position information of the vehicle and the second map data.

According to the travel road determination method as described above, the travel road determination apparatus 100 accurately determines a road type of the road on which the vehicle is traveling in the connection area between the first-type road represented by the first map data including the road information of each traffic lane and the second-type road represented by the second map data including the road information of each road information.

### Second Embodiment

A travel road determination apparatus and a travel road determination method according to the second embodiment will be described. The second embodiment is a subordinate concept of the first embodiment, and the travel road determination apparatus according to the second embodiment includes each configuration of the travel road determination apparatus 100 according to the first embodiment. Note that description of configurations and operations similar to those of the first embodiment will be omitted.

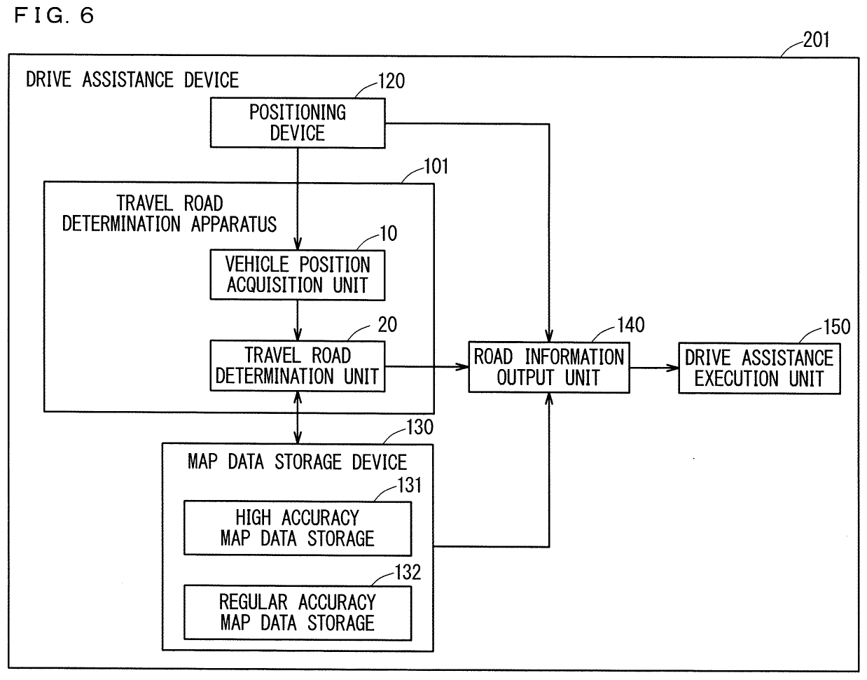

FIG. 6 is a functional block diagram illustrating a configuration of a travel road determination apparatus 101 and a drive assistance device 201 according to the second embodiment. The travel road determination apparatus 101 includes a vehicle position acquisition unit 10 and a travel road determination unit 20. The drive assistance device 201 includes a positioning device 120, a travel road determination apparatus 101, a map data storage device 130, a road information output unit 140, and a drive assistance execution unit 150.

The positioning device 120 measures a travel position of a vehicle. The positioning device 120 is provided in the vehicle. The positioning device 120 includes at least one of a receiver that receives signals of the Global Navigation Satellite System (GNSS), a gyro sensor, a vehicle speed sensor, and the like, for example.

The map data storage device 130 includes a high accuracy map data storage 131 and a regular accuracy map data storage 132. The map data storage device 130 is, for example, provided in a server.

The high accuracy map data storage 131 stores high accuracy map data corresponding to the first map data described in the first embodiment. The high accuracy map data includes road shape data of each traffic lane. The road shape data of each traffic lane may be data based on a center line of the traffic lane, or may be data based on a line of other road marking. The high accuracy map data has accuracy of approximately several centimeters. According to the high accuracy map data, the road shape is represented in each traffic lane, which is more detailed than in each road. In the second embodiment, the first-type road represented by the high accuracy map data is a freeway. The first-type road is an advanced drive assistance road that can be applied to drive assistance control or automated drive control. The freeway includes a main lane and a dedicated traffic lane. The dedicated traffic lane is, for example, a traffic lane (an entrance-dedicated traffic lane and an exit-dedicated traffic lane) that connects the main lane and a gate of the freeway. The gate is, for example, a toll gate.

The regular accuracy map data storage 132 stores regular accuracy map data corresponding to the second map data described in the first embodiment. The regular accuracy map data includes road shape data of each road. The road shape data of each road may be data based on a center line of a road, or may be other data indicating the road shape. The regular accuracy map data has accuracy of approximately several meters. According to the regular accuracy map data, the road shape is represented in each road. In other words, according to the regular accuracy map data, even when a road includes two or more traffic lanes, the road is represented as one road. In the second embodiment, the second-type road represented by the regular accuracy map data includes a freeway and a general road. The second-type road is a road that can be applied to navigation of a vehicle, such as route search and route guidance. The general road includes a regular road (the main lane of the general road) and a connection road. The connection road connects a freeway and a regular road. For example, at least one side of a road link of a connection road is connected to a road link of a freeway, whereas neither end of a road link of a regular road is connected to a road link of a freeway.

As described above, both of the high accuracy map data and the regular accuracy map data are provided for the freeway according to the second embodiment. Thus, the freeway can be represented by any one of the high accuracy map data and the regular accuracy map data. In contrast, the high accuracy map data is not provided for the general road. Thus, the general road is a road that is represented only by the regular accuracy map data, and in which advanced drive assistance cannot be implemented.

The vehicle position acquisition unit 10 acquires position information of a vehicle. The vehicle position acquisition unit 10 includes, for example, an interface into which data output from the positioning device 120 can be input. Further, the position information of a vehicle according to the second embodiment includes time series information that stores travel positions of the vehicle, i.e., travel route history information.

The travel road determination unit 20 performs the following processing as the first determination processing according to the second embodiment. The travel road determination unit 20 determines whether or not the vehicle is traveling on a freeway, based on the first position information of the vehicle. When the vehicle is traveling on a freeway, the travel road determination unit 20 sets travel road information to the freeway. The travel road information is information for determining whether map data that the travel road determination unit 20 is to acquire from the map data storage device 130 is the high accuracy map data or the regular accuracy map data. The travel road determination unit 20 acquires the high accuracy map data representing the freeway around the travel position of the vehicle from the high accuracy map data storage 131, based on the travel road information and the second position information of the vehicle. The travel position of the vehicle in the second position information corresponds to a position ahead of the travel position of the vehicle in the first position information in a traveling direction of the vehicle. The travel road determination unit 20 determines whether or not the vehicle has started traveling on a connection road, based on the second position information and the high accuracy map data. In other words, the travel road determination unit 20 determines whether the vehicle is continuously traveling on the freeway, or has started traveling on the connection road. The travel road determination unit 20 outputs determination results to the road information output unit 140.

The travel road determination unit 20 performs the following processing as the second determination processing according to the second embodiment. The travel road determination unit 20 determines whether or not the vehicle is traveling on the connection road, based on the third position information of the vehicle. When the vehicle is traveling on the connection road, the travel road determination unit 20 sets the travel road information to the connection road. The travel road determination unit 20 acquires the regular accuracy map data representing the connection road around the travel position of the vehicle from the map data storage device 130, based on the travel road information and the fourth position information of the vehicle. The travel position of the vehicle in the fourth position information corresponds to a position ahead of the travel position of the vehicle in the third position information in a traveling direction of the vehicle. The travel road determination unit 20 determines whether or not the vehicle has started traveling on the freeway, based on the fourth position information and the regular accuracy map data. In other words, the travel road determination unit 20 determines whether the vehicle is continuously traveling on the connection road, or has started traveling on the freeway. The travel road determination unit 20 outputs determination results to the road information output unit 140.

The road information output unit 140 outputs the high accuracy map data to the drive assistance execution unit 150, based on the determination results indicating that the vehicle is traveling on the freeway. The drive assistance execution unit 150 is, for example, ADAS, or a device or an application related to ADAS.

The drive assistance execution unit 150 executes advanced drive assistance of each traffic lane, based on the high accuracy map data.

These functions of the vehicle position acquisition unit 10 and the travel road determination unit 20 are implemented by the processing circuit illustrated in FIG. 2 or FIG. 3. Further, the drive assistance device 201 also includes a similar processing circuit for implementing the functions of the road information output unit 140 and the drive assistance execution unit 150.

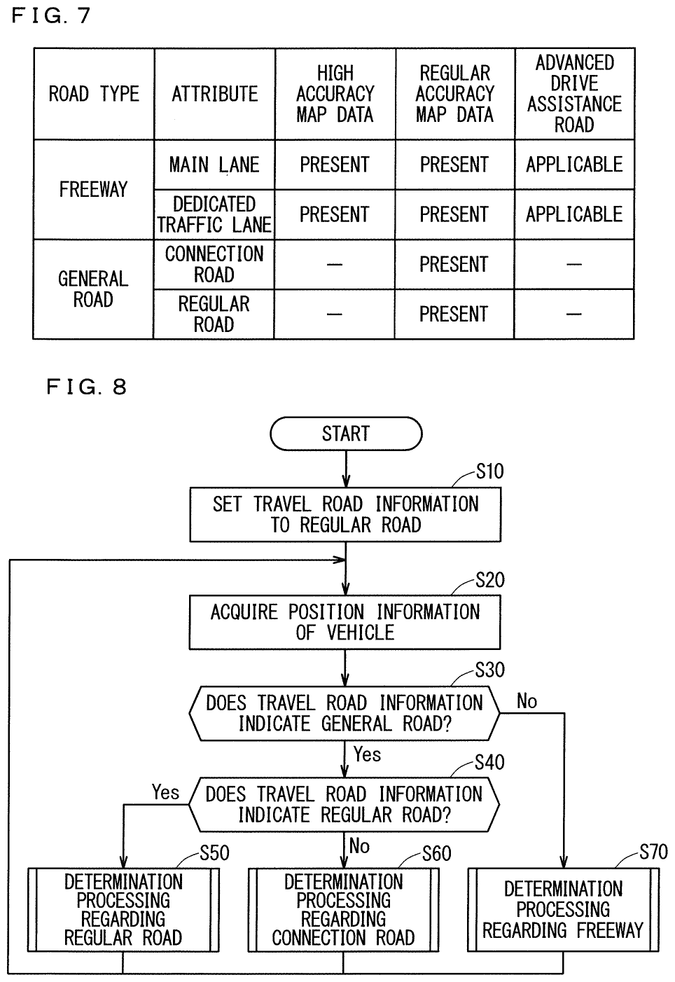

FIG. 7 is a diagram illustrating a relationship between road types and pieces of map data according to the second embodiment. In the main lane and the dedicated traffic lane of a freeway, the high accuracy map data is provided. The main lane and the dedicated traffic lane of a freeway are each an advanced drive assistance road. Thus, when the vehicle is traveling on the main lane or the dedicated traffic lane of a freeway, the road information output unit 140 outputs the high accuracy map data to the drive assistance execution unit 150. In contrast, in the regular road and the connection road of a general road, the high accuracy map data is not provided, and only the regular accuracy map data is provided. Neither the regular road nor the connection road is an advanced drive assistance road.

FIG. 8 is a flowchart illustrating a travel road determination method according to the second embodiment. In the second embodiment, the description begins with starting an engine of a vehicle.

In Step S10, when an engine of a vehicle is started, the travel road determination unit 20 sets the travel road information to the regular road.

In Step S20, the vehicle position acquisition unit 10 acquires the position information of the vehicle from the positioning device 120.

In Step S30, the travel road determination unit 20 determines whether or not the travel road information indicates the general road. When the travel road information indicates the general road, Step S40 is executed. When the travel road information does not indicate the general road, in other words, when the travel road information indicates the freeway, Step S70 is executed.

In Step S40, the travel road determination unit 20 determines whether or not the travel road information indicates the regular road in the general road. When the travel road information indicates the regular road, Step S50 is executed. When the travel road information does not indicate the regular road, in other words, when the travel road information indicates the connection road, Step S60 is executed.

In Step S50, the travel road determination unit 20 executes determination processing regarding the regular road. The details thereof will be described later.

In Step S60, the travel road determination unit 20 executes determination processing regarding the connection road. The details thereof will be described later.

In Step S70, the travel road determination unit 20 executes determination processing regarding the freeway. The details thereof will be described later.

After the determination processing of one of Steps S50 to S70, Step S20 is executed again.

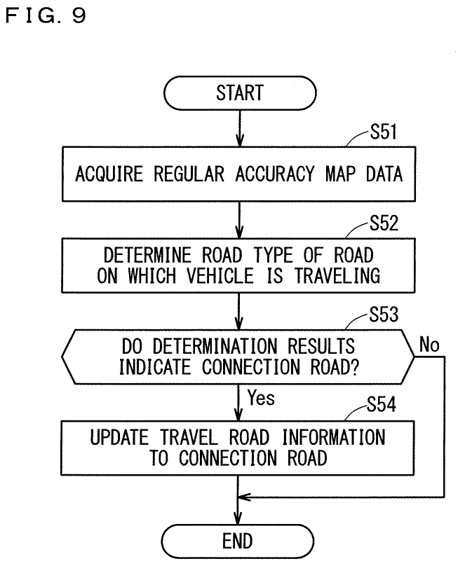

FIG. 9 is a flowchart illustrating the determination processing regarding the regular road according to the second embodiment.

In Step S51, the travel road determination unit 20 acquires the regular accuracy map data, based on the travel road information and the position information of the vehicle. More specifically, the travel road determination unit 20 selects the regular accuracy map data because the travel road information indicates the regular road. Then, the travel road determination unit 20 acquires the regular accuracy map data corresponding to the position information.

In Step S52, the travel road determination unit 20 determines a road type of the road on which the vehicle is traveling, based on the regular accuracy map data and the position information of the vehicle. Specifically, the travel road determination unit 20 compares the regular accuracy map data and the travel position of the vehicle included in the position information of the vehicle, and thereby determines the road type.

In Step S53, the travel road determination unit 20 determines whether or not determination results indicate the connection road. When the determination results indicate the connection road, Step S54 is executed. When the determination results do not indicate the connection road, in other words, when the determination results indicate the regular road, the determination processing regarding the regular road ends, and the processing returns back to the flowchart illustrated in FIG. 8. Then, Step S20 is executed again.

In Step S54, the travel road determination unit 20 updates the travel road information to the connection road. Through the above, the determination processing regarding the regular road ends, and the processing returns back to the flowchart illustrated in FIG. 8. Then, Step S20 is executed again.

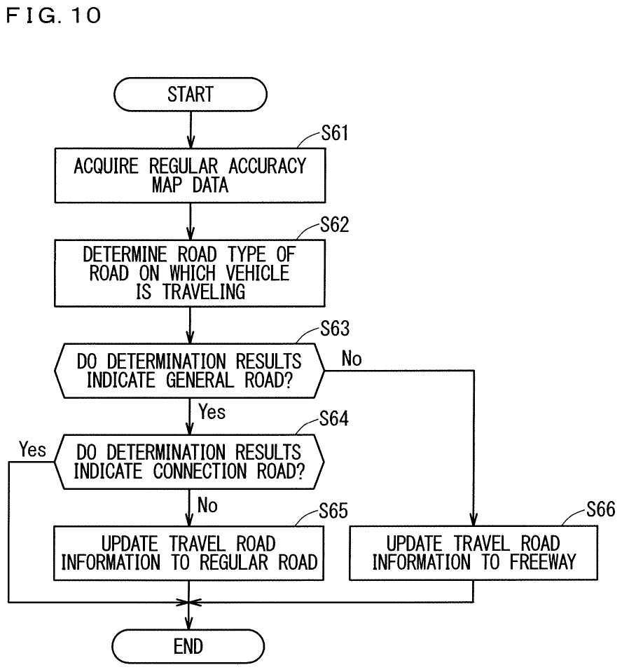

FIG. 10 is a flowchart illustrating the determination processing regarding the connection road according to the second embodiment.

In Step S61, the travel road determination unit 20 acquires the regular accuracy map data, based on the travel road information and the position information of the vehicle. More specifically, the travel road determination unit 20 selects the regular accuracy map data because the travel road information indicates the connection road. Then, the travel road determination unit 20 acquires the regular accuracy map data corresponding to the position information.

In Step S62, the travel road determination unit 20 determines a road type of the road on which the vehicle is traveling, based on the regular accuracy map data and the position information of the vehicle. Specifically, the travel road determination unit 20 compares the regular accuracy map data and the travel position of the vehicle included in the position information of the vehicle, and thereby determines the road type.

In Step S63, the travel road determination unit 20 determines whether or not determination results indicate the general road. When the determination results indicate the general road, Step S64 is executed. When the determination results do not indicate the general road, in other words, when the determination results indicate the freeway, Step S66 is executed.

In Step S64, the travel road determination unit 20 determines whether or not the determination results indicate the connection road. When the determination results indicate the connection road, the determination processing regarding the connection road ends, and the processing returns back to the flowchart illustrated in FIG. 8. Then, Step S20 is executed again. When the determination results do not indicate the connection road, in other words, when the determination results do not indicate the regular road, Step S65 is executed.

In Step S65, the travel road determination unit 20 updates the travel road information to the regular road.

In Step S66, the travel road determination unit 20 updates the travel road information to the freeway.

Through the above, the determination processing regarding the connection road ends, and the processing returns back to the flowchart illustrated in FIG. 8. Then, Step S20 is executed again.

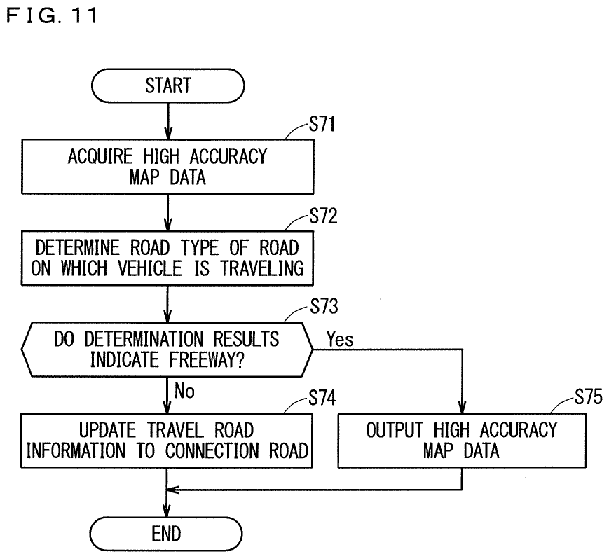

FIG. 11 is a flowchart illustrating the determination processing regarding the freeway according to the second embodiment.

In Step S71, the travel road determination unit 20 acquires the high accuracy map data, based on the travel road information and the position information of the vehicle. More specifically, the travel road determination unit 20 selects the high accuracy map data because the travel road information indicates the freeway. Then, the travel road determination unit 20 acquires the high accuracy map data corresponding to the position information.

In Step S72, the travel road determination unit 20 determines a road type of the road on which the vehicle is traveling, based on the high accuracy map data and the position information of the vehicle. Specifically, the travel road determination unit 20 compares the high accuracy map data and the travel position of the vehicle included in the position information of the vehicle, and thereby determines the road type.

In Step S73, the travel road determination unit 20 determines whether or not determination results indicate the freeway. When the determination results do not indicate the freeway, Step S74 is executed. When the determination results indicate the freeway, Step S75 is executed.

In Step S74, the travel road determination unit 20 updates the travel road information to the connection road.

In Step S75, the travel road determination unit 20 outputs the determination results indicating that the vehicle is traveling on the freeway to the road information output unit 140. The road information output unit 140 outputs the high accuracy map data to the drive assistance execution unit 150, based on the determination results.

Through the above, the determination processing regarding the freeway ends, and the processing returns back to the flowchart illustrated in FIG. 8. Then, Step S20 is executed again.

(Determination Processing Regarding Vehicle Entering Freeway from General Road)

Next, an example of determination processing when the vehicle enters the freeway from the general road will be described.

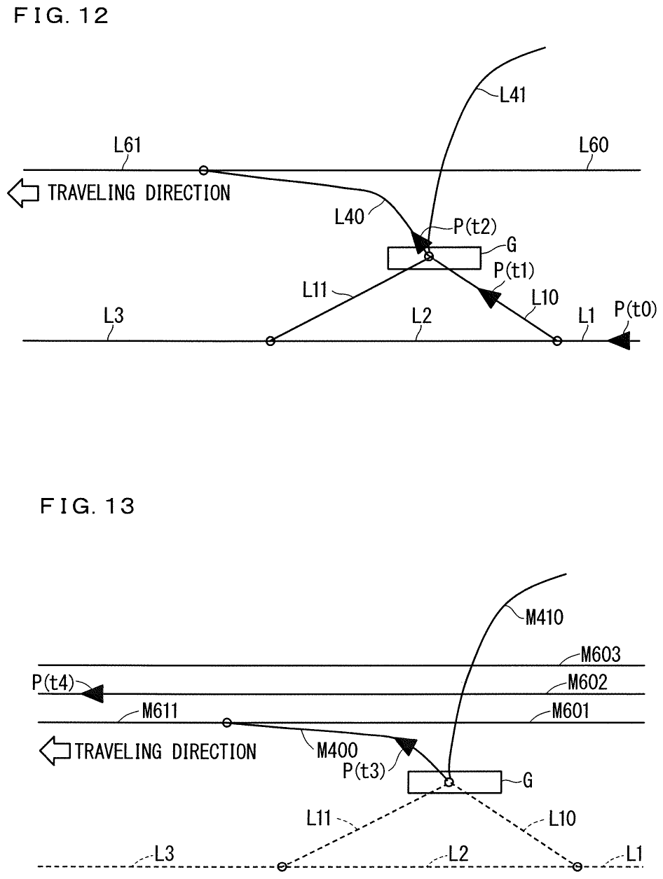

FIG. 12 is a diagram illustrating an example of road information based on the regular accuracy map data around a gate G of the freeway. The main lane of the freeway is represented by road links L60 and L61. The regular road is represented by road links L1 to L3. The main lane of the freeway extends along the general road, and is provided alongside the general road. The connection road is represented by road links L10 and L11. The connection road connects the gate G of the freeway and the regular road. The entrance-dedicated traffic lane provided between the main lane of the freeway and the gate G is represented by road links L40 and L41. Note that the road link L41 indicates an entrance-dedicated traffic lane connecting to an oncoming traffic lane of the main lane of the freeway.

FIG. 13 is a diagram illustrating an example of road information based on the high accuracy map data around the gate G of the freeway the same as FIG. 12. The main lane of the freeway includes a first traffic lane to a third traffic lane. The first traffic lane is represented by traffic lane links M601 and M611. The second traffic lane is represented by a traffic lane link M602. The third traffic lane is represented by a traffic lane link M603. The traffic lane links M601 to M603 correspond to the road link L60 of the regular accuracy map data. The entrance-dedicated traffic lane provided between the main lane of the freeway and the gate G is represented by traffic lane links M400 and M410. The traffic lane links M400 and M410 correspond to the road links L40 and L41 of the regular accuracy map data, respectively. Note that, for reference, the road information of the general road represented in the regular accuracy map is indicated in the broken line.

In Step S10, when an engine of a vehicle is started, the travel road determination unit 20 sets the travel road information to the regular road. Subsequently, the vehicle arrives in the area illustrated in FIG. 12.

In Step S20, the vehicle position acquisition unit 10 acquires the position information at a position P (t0). The position information includes the time series information of travel positions until the vehicle arrives at the position P (t0). Note that, in a section from a position at which the engine is started to the position P (t0), the travel road determination apparatus 101 compares the regular accuracy map data and the time series information of travel positions of the vehicle, and updates the travel road information. Thus, the travel road information when the vehicle position acquisition unit 10 acquires the position information at the position P (t0) indicates the regular road in the general road.

In Step S30, the travel road determination unit 20 determines whether or not the travel road information indicates the general road. The travel road information at the time point when the vehicle arrives at the position P (t0) indicates the general road, and accordingly Step S40 is executed.

In Step S40, the travel road determination unit 20 determines whether or not the travel road information indicates the regular road. The travel road information indicates the regular road, and accordingly the determination processing regarding the regular road of Step S50 (Step S51 and later steps) is executed.

In Step S51, the travel road determination unit 20 acquires the regular accuracy map data around the position P (t0), based on the travel road information and the position information. More specifically, the travel road determination unit 20 selects the regular accuracy map data because the travel road information indicates the regular road, and furthermore acquires the regular accuracy map data around the position P (t0), based on the information of the position P (t0). In other words, the travel road determination unit 20 acquires the regular accuracy map data illustrated in FIG. 12.

In Step S52, the travel road determination unit 20 compares the regular accuracy map data and the time series information of travel positions up to the position P (t0), and determines that the vehicle is traveling on the road link L1 of the regular road.

In Step S53, the travel road determination unit 20 determines whether or not determination results indicate the connection road. The determination results at the position P (t0) indicate the regular road, and accordingly the processing returns back to the flowchart illustrated in FIG. 8. Then, Step S20 is executed again.

In Step S20, the vehicle position acquisition unit 10 acquires the position information at a position P (t1). The position information includes the time series information of travel positions until the vehicle arrives at the position P (t1).

In Step S30, the travel road determination unit 20 determines whether or not the travel road information indicates the general road. The travel road information that the travel road determination unit 20 acquires at this time point still indicates the regular road, i.e., the general road, and accordingly Step S40 is executed.

In Step S40, the travel road determination unit 20 determines whether or not the travel road information indicates the regular road. The travel road information indicates the regular road, and accordingly the determination processing regarding the regular road of Step S50 (Step S51 and later steps) is executed.

In Step S51, the travel road determination unit 20 acquires the regular accuracy map data around the position P (t1), based on the travel road information and the position information. More specifically, the travel road determination unit 20 selects the regular accuracy map data because the travel road information indicates the regular road, and furthermore acquires the regular accuracy map data around the position P (t1), based on the information of the position P (t1).

In Step S52, the travel road determination unit 20 compares the regular accuracy map data and the time series information of travel positions up to the position P (t1), and determines that the vehicle is traveling on the road link L10 of the connection road. In other words, the travel road determination unit 20 determines that the vehicle has started traveling on the connection road.

In Step S53, the travel road determination unit 20 determines whether or not determination results indicate the connection road. The determination results at the position P (t1) indicate the connection road, and accordingly Step S54 is executed.

In Step S54, the travel road determination unit 20 updates the travel road information to the connection road. Through the above, the determination processing regarding the regular road ends, and the processing returns back to the flowchart illustrated in FIG. 8. Then, Step S20 is executed again.

In Step S20, the vehicle position acquisition unit 10 acquires the position information at a position P (t2). The position information includes the time series information of travel positions until the vehicle arrives at the position P (t2).

In Step S30, the travel road determination unit 20 determines whether or not the travel road information indicates the general road. The travel road information that the travel road determination unit 20 acquires at this time point still indicates the connection road, i.e., the general road, and accordingly Step S40 is executed.

In Step S40, the travel road determination unit 20 determines whether or not the travel road information indicates the regular road. The travel road information indicates the connection road, and accordingly the determination processing regarding the connection road of Step S60 (Step S61 and later steps) is executed.

In Step S61, the travel road determination unit 20 acquires the regular accuracy map data around the position P (t2), that is, the regular accuracy map data illustrated in FIG. 12, based on the travel road information and the position information. More specifically, the travel road determination unit 20 selects the regular accuracy map data because the travel road information indicates the connection road, and furthermore acquires the regular accuracy map data around the position P (t2), based on the information of the position P (t2).

In Step S62, the travel road determination unit 20 compares the regular accuracy map data and the time series information of travel positions up to the position P (t2), and determines that the vehicle is traveling on the road link L40 of the freeway. In other words, the travel road determination unit 20 determines that the vehicle has started traveling on the freeway.

In Step S63, the travel road determination unit 20 determines whether or not determination results indicate the general road. The determination results at the position P (t2) indicate the freeway, and accordingly Step S66 is executed.

In Step S66, the travel road determination unit 20 updates the travel road information to the freeway. Through the above, the determination processing regarding the connection road ends, and the processing returns back to the flowchart illustrated in FIG. 8. Then, Step S20 is executed again.

In Step S20, the vehicle position acquisition unit 10 acquires the position information at a position P (t3). The position information includes the time series information of travel positions until the vehicle arrives at the position P (t3).

In Step S30, the travel road determination unit 20 determines whether or not the travel road information indicates the general road. The travel road information that the travel road determination unit 20 acquires at this time point indicates the freeway, and accordingly the determination processing regarding the freeway of Step S70 (Step S71 and later steps) is executed.

In Step S71, the travel road determination unit 20 acquires the high accuracy map data around the position P (t3), based on the travel road information and the position information. More specifically, the travel road determination unit 20 selects the high accuracy map data because the travel road information indicates the freeway, and furthermore acquires the high accuracy map data around the position P (t3), based on the information of the position P (t3). In other words, the travel road determination unit 20 acquires the high accuracy map data illustrated in FIG. 13.

In Step S72, the travel road determination unit 20 compares the high accuracy map data and the time series information of travel positions up to the position P (t3), and determines that the vehicle is traveling on the traffic lane link M400 of the entrance-dedicated traffic lane of the freeway.

In Step S73, the travel road determination unit 20 determines whether or not determination results indicate the freeway. The determination results at the position P (t3) indicate the freeway, and accordingly Step S75 is executed.

In Step S75, the travel road determination unit 20 outputs the determination results indicating that the travel road information indicates the freeway to the road information output unit 140. The road information output unit 140 outputs the high accuracy map data to the drive assistance execution unit 150, based on the determination results. When the drive assistance execution unit 150 is the ADAS, the ADAS starts drive assistance such as automated traveling. Through the above, the determination processing regarding the freeway ends, and the processing returns back to the flowchart illustrated in FIG. 8. Then, Step S20 is executed again.

In Step S20, the vehicle position acquisition unit 10 acquires the position information at a position P (t4). The position information includes the time series information of travel positions until the vehicle arrives at the position P (t4).

In Step S30, the travel road determination unit 20 determines whether or not the travel road information indicates the general road. The travel road information that the travel road determination unit 20 acquires at this time point indicates the freeway, and accordingly the determination processing regarding the freeway of Step S70 (Step S71 and later steps) is executed.

In Step S71, the travel road determination unit 20 acquires the high accuracy map data around the position P (t4), based on the travel road information and the position information. More specifically, the travel road determination unit 20 selects the high accuracy map data because the travel road information indicates the freeway, and furthermore acquires the high accuracy map data around the position P (t4), based on the information of the position P (t4).

In Step S72, the travel road determination unit 20 compares the high accuracy map data and the time series information of travel positions up to the position P (t4), and determines that the vehicle is traveling on the traffic lane link M602 of the second traffic lane of the freeway. More specifically, the travel road determination unit 20 determines that the vehicle has moved from the traffic lane link M400 of the entrance-dedicated traffic lane to M611 of the first traffic lane, and then to the traffic lane link M602 of the second traffic lane.

In Step S73, the travel road determination unit 20 determines whether or not determination results indicate the freeway. The determination results at the position P (t4) indicate the freeway, and accordingly Step S75 is executed.

In Step S75, the travel road determination unit 20 outputs the determination results indicating that the vehicle is traveling on the freeway to the road information output unit 140. The road information output unit 140 outputs the high accuracy map data to the drive assistance execution unit 150, based on the determination results. When the drive assistance execution unit 150 is the ADAS, the ADAS continues drive assistance such as automated traveling. Through the above, the determination processing regarding the freeway ends, and the processing returns back to the flowchart illustrated in FIG. 8. Then, Step S20 is executed again.

In this manner, when the vehicle enters the freeway from the general road, the travel road determination unit 20 executes determination as to whether the vehicle is to continuously travel on the general road or the vehicle has started traveling on the freeway by using the regular accuracy map data.

Further, in the example described above, an example in which the vehicle enters the freeway from the connection road has described; however, when the vehicle moves to the regular road through the road links L10 and L11 of the connection road, Step S50 is executed after Step S60 illustrated in FIG. 9 is executed.

(Determination Processing Regarding Vehicle Entering General Road from Freeway)

Next, an example of determination processing when the vehicle enters the general road from the freeway will be described.

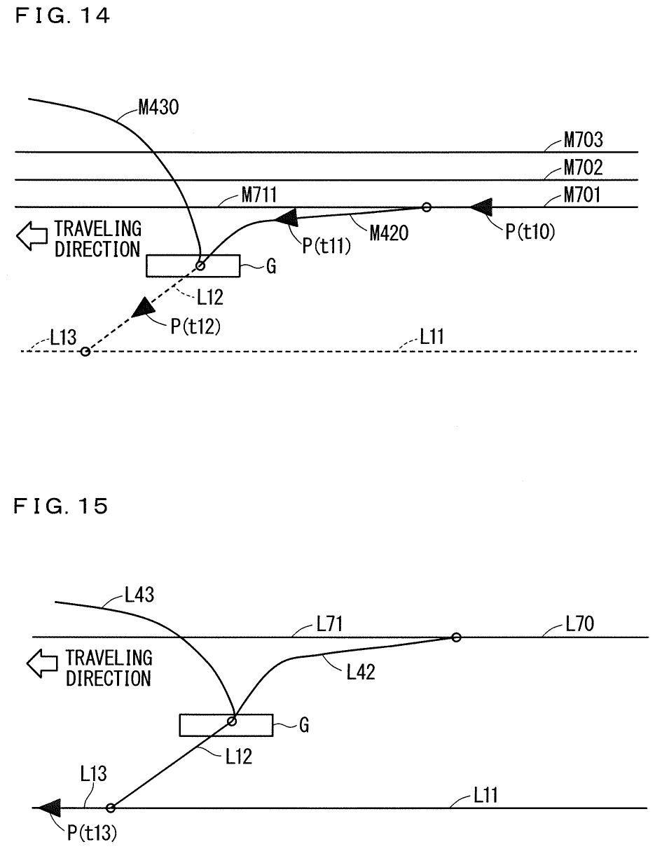

FIG. 14 is a diagram illustrating another example of road information based on the high accuracy map data around the gate G of the freeway. The main lane of the freeway includes a first traffic lane to a third traffic lane. The first traffic lane is represented by traffic lane links M701 and M711. The second traffic lane is represented by a traffic lane link M702. The third traffic lane is represented by a traffic lane link M703. The exit-dedicated traffic lane provided between the main lane of the freeway and the gate G is represented by traffic lane links M420 and M430. The traffic lane link M430 indicates an exit-dedicated road connecting to an oncoming traffic lane of the main lane of the freeway. Note that, for reference, the road information of the general road represented in the regular accuracy map is indicated in the broken line.

FIG. 15 is a diagram illustrating another example of road information based on the regular accuracy map data around the gate G of the freeway the same as FIG. 14. The main lane of the freeway is represented by road links L70 and L71. The road link L70 corresponds to the traffic lane links M701 to M703 of the high accuracy map data. The regular road is represented by road links L11 and L13. The general road extends along the main lane of the freeway, and is provided alongside the freeway. The connection road is represented by a road link L12. The connection road connects the gate G of the freeway and the regular road. The exit-dedicated road provided between the main lane of the freeway and the gate G is represented by road links L42 and L43. The road links L42 and L43 correspond to the traffic lane links M420 and M430 in the high accuracy map data, respectively.

In Step S20, the vehicle position acquisition unit 10 acquires the position information at a position P (t10). The position information includes the time series information of travel positions until the vehicle arrives at the position P (t10).

In Step S30, the travel road determination unit 20 determines whether or not the travel road information indicates the general road. The travel road information at the time point when the vehicle arrives at the position P (t10) indicates the freeway, and accordingly the determination processing regarding the freeway of Step S70 (Step S71 and later steps) is executed.

In Step S71, the travel road determination unit 20 acquires the high accuracy map data around the position P (t10), based on the travel road information and the position information. More specifically, the travel road determination unit 20 selects the high accuracy map data because the travel road information indicates the freeway, and furthermore acquires the high accuracy map data around the position P (t10), based on the information of the position P (t10). In other words, the travel road determination unit 20 acquires the high accuracy map data illustrated in FIG. 14.

In Step S72, the travel road determination unit 20 compares the high accuracy map data and the time series information of travel positions up to the position P (t10). Specifically, the travel road determination unit 20 compares information of positions of the traffic lane links M701 to M703 and the time series information of travel positions of the vehicle, i.e., a movement track of the vehicle, until the vehicle arrives at the position P (t10). Thus, the travel road determination unit 20 can also highly accurately determine whether or not the vehicle has started moving toward the traffic lane link M420 of the exit-dedicated traffic lane on the left side. Here, as a result of the comparing, the travel road determination unit 20 determines that the vehicle is traveling on the traffic lane link M701 of the first traffic lane of the freeway.

In Step S73, the travel road determination unit 20 determines whether or not determination results indicate the freeway. The determination results at the position P (t10) indicate the freeway, and accordingly Step S75 is executed.

In Step S75, the travel road determination unit 20 outputs the determination results indicating that the vehicle is traveling on the freeway to the road information output unit 140. The road information output unit 140 outputs the high accuracy map data to the drive assistance execution unit 150, based on the determination results. Through the above, the determination processing regarding the freeway ends, and the processing returns back to the flowchart illustrated in FIG. 8. Then, Step S20 is executed again.

In Step S20, the vehicle position acquisition unit 10 acquires the position information at a position P (t11). The position information includes the time series information of travel positions until the vehicle arrives at the position P (t11).

In Step S30, the travel road determination unit 20 determines whether or not the travel road information indicates the general road. The travel road information that the travel road determination unit 20 acquires at the time point of arrival at the position P (t11) indicates the freeway, and accordingly the determination processing regarding the freeway of Step S70 (Step S71 and later steps) is executed.

In Step S71, the travel road determination unit 20 acquires the high accuracy map data around the position P (t11), based on the travel road information and the position information. More specifically, the travel road determination unit 20 selects the high accuracy map data because the travel road information indicates the freeway, and furthermore acquires the high accuracy map data around the position P (t11), based on the information of the position P (t11).

In Step S72, the travel road determination unit 20 compares the high accuracy map data and the time series information of travel positions up to the position P (t11), and determines that the vehicle is traveling on the traffic lane link M420 of the exit-dedicated traffic lane of the freeway. In this case, the travel road determination unit 20 performs determination as to whether the vehicle enters the traffic lane link M420 of the exit-dedicated traffic lane from the traffic lane link M701 of the first traffic lane, or travels straight to the traffic lane link M711 from the traffic lane link M701, based on the high accuracy map data. Thus, the traveling traffic lane of the vehicle can be highly accurately determined.

In Step S73, the travel road determination unit 20 determines whether or not determination results indicate the freeway. The determination results at the position P (t11) indicate the freeway, and accordingly Step S75 is executed.

In Step S75, the travel road determination unit 20 outputs the determination results indicating that the vehicle is traveling on the freeway to the road information output unit 140. The road information output unit 140 outputs the high accuracy map data to the drive assistance execution unit 150, based on the determination results. Through the above, the determination processing regarding the freeway ends, and the processing returns back to the flowchart illustrated in FIG. 8. Then, Step S20 is executed again.

In Step S20, the vehicle position acquisition unit 10 acquires the position information at a position P (t12). The position information includes the time series information of travel positions until the vehicle arrives at the position P (t12).

In Step S30, the travel road determination unit 20 determines whether or not the travel road information indicates the general road. The travel road information that the travel road determination unit 20 acquires at the time point of arrival at the position P (t12) indicates the freeway, and accordingly the determination processing regarding the freeway of Step S70 (Step S71 and later steps) is executed.

In Step S71, the travel road determination unit 20 acquires the high accuracy map data around the position P (t12), based on the travel road information and the position information. More specifically, the travel road determination unit 20 selects the high accuracy map data because the travel road information indicates the freeway, and furthermore acquires the high accuracy map data around the position P (t12), based on the information of the position P (t12).

In Step S72, the travel road determination unit 20 compares the high accuracy map data and the time series information of travel positions up to the position P (t12). The vehicle is past the gate G, and the high accuracy map data does not exist, in other words, only the connection road exists, down the exit-dedicated traffic lane. Thus, the travel road determination unit 20 determines traveling on the connection road. In other words, the travel road determination unit 20 determines that the vehicle has started traveling on the connection road.

In Step S73, the travel road determination unit 20 determines whether or not determination results indicate the freeway. The determination results at the position P (t12) indicate the connection road, and accordingly Step S74 is executed.

In Step S75, the travel road determination unit 20 updates the travel road information to the connection road. Through the above, the determination processing regarding the freeway ends, and the processing returns back to the flowchart illustrated in FIG. 8. Then, Step S20 is executed again.

In Step S20, the vehicle position acquisition unit 10 acquires the position information at a position P (t13). The position information includes the time series information of travel positions until the vehicle arrives at the position P (t13).

In Step S30, the travel road determination unit 20 determines whether or not the travel road information indicates the general road. The travel road information that the travel road determination unit 20 acquires at this time point indicates the connection road, i.e., the general road, and accordingly Step S40 is executed.

In Step S40, the travel road determination unit 20 determines whether or not the travel road information indicates the regular road. The travel road information indicates the connection road, and accordingly the determination processing regarding the connection road of Step S60 (Step S61 and later steps) is executed.

In Step S61, the travel road determination unit 20 acquires the regular accuracy map data around the position P (t13), based on the travel road information and the position information. More specifically, the travel road determination unit 20 selects the regular accuracy map data because the travel road information indicates the connection road, and furthermore acquires the regular accuracy map data around the position P (t13), based on the information of the position P (t13). In other words, the travel road determination unit 20 acquires the regular accuracy map data illustrated in FIG. 15 specifically.

In Step S62, the travel road determination unit 20 compares the regular accuracy map data and the time series information of travel positions up to the position P (t13), and determines that the vehicle is traveling on the road link L13 of the regular road.

In Step S63, the travel road determination unit 20 determines whether or not determination results indicate the general road. The determination results at the position P (t13) indicate the regular road, i.e., the general road, and accordingly Step S64 is executed.

In Step S64, the travel road determination unit 20 determines whether or not the determination results indicate the connection road. The determination results at the position P (t13) indicate the regular road, and accordingly Step S65 is executed.

In Step S65, the travel road determination unit 20 updates the travel road information to the regular road. Through the above, the determination processing regarding the connection road ends, and the processing returns back to the flowchart illustrated in FIG. 8. Then, Step S20 is executed again.

In this manner, when the vehicle enters the general road from the freeway, the travel road determination unit 20 executes determination as to whether the vehicle is to continuously travel on the freeway or the vehicle has started traveling on the general road by using the high accuracy map data.

As described above, in the first determination processing, the travel road determination unit 20 determines whether or not the vehicle that is determined to be traveling on the freeway based on the first position information (position P (t11)) of the vehicle has started traveling on the connection road, based on the second position information (position P (t12)) and the high accuracy map data. In other words, at the position P (t12), the travel road determination unit 20 does not perform determination of a road type of the road on which the vehicle travels by using the regular accuracy map data. The travel road determination unit 20 determines the road type, based on only the high accuracy map data out of two pieces of map data and the time series information of travel positions up to the position P (t12).

In the second determination processing, the travel road determination unit 20 determines whether or not the vehicle that is determined to be traveling on the connection road based on the third position information (position P)) of the vehicle has started traveling on the freeway, based on the fourth position information (position P (t2)) and the regular accuracy map data. In other words, at the position P (t2), the travel road determination unit 20 does not perform determination of a road type of the road on which the vehicle travels by using the high accuracy map data. The travel road determination unit 20 determines the road type based on only the regular accuracy map data out of two pieces of map data and the time series information of travel positions up to the position P (t2).

When the freeway extends along the general road and is provided alongside the general road, it is generally difficult to accurately determine the road type of the road on which the vehicle is traveling. However, the travel road determination unit 20 according to the second embodiment determines the road type by using only one piece of map data out of the regular accuracy map data and the high accuracy map data. Further, in this case, the travel road determination unit 20 compares the travel route history information being the time series information of travel positions and the map data. Thus, the travel road determination apparatus 101 accurately determines the road type also in a section where the freeway and the general road are close to each other. As a result, at the timing when the road type of the road on which the vehicle travels switches, information required by the ADAS and the like is accurately output, allowing for implementation of drive assistance with high accuracy.

Depending on circumstances of provision of the high accuracy map data, there are sections where the freeway is represented only by the regular accuracy map data. Alternatively, despite not being a freeway, there are a limited highway, a national highway, and the like that are represented by the high accuracy map data. In the second embodiment, the freeway is illustrated as an example of the first-type road, and the general road is illustrated as an example of the second-type road. However, the first-type road may be a limited highway, a national highway, or the like represented by the high accuracy map data, and the second-type road may be a freeway represented by the regular accuracy map data.

### First Modification of Second Embodiment

When the engine of the vehicle is started in a service area or a parking area pertaining to the freeway, in Step S10, the travel road determination unit 20 according to the first modification of the second embodiment sets the travel road information to the connection road.

### Second Modification of Second Embodiment

The travel road determination apparatus 101 according to the second modification of the second embodiment includes a storage (not illustrated). The storage stores the travel road information when the engine of the vehicle is last stopped. In Step S10 illustrated in FIG. 8, the travel road determination unit 20 reads the travel road information from the storage.

### Third Modification of Second Embodiment

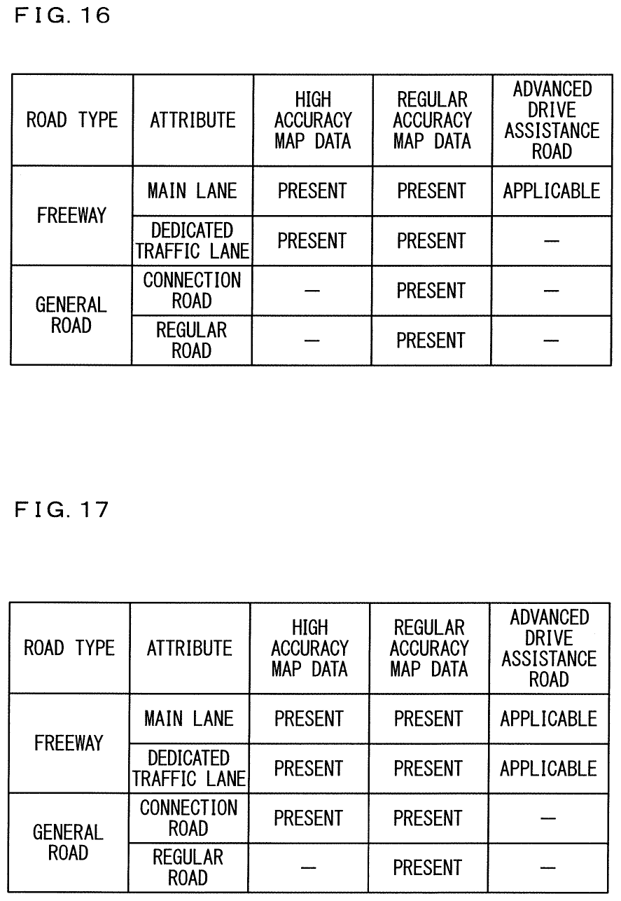

FIG. 16 is a diagram illustrating an example of a relationship between road types and pieces of map data according to the third modification of the second embodiment. The freeway being the first-type road includes the main lane as an advanced drive assistance road, and the dedicated traffic lane as a non-advanced drive assistance road, which is not the advanced drive assistance road. In other words, the dedicated traffic lane of the freeway is represented by the high accuracy map data, but advanced drive assistance is not executed therein. Thus, when the vehicle travels on the dedicated traffic lane of the freeway, the road information output unit 140 does not output the high accuracy map data to the ADAS and the like.

### Fourth Modification of Second Embodiment

FIG. 17 is a diagram illustrating an example of a relationship between road types and pieces of map data according to the fourth modification of the second embodiment. Here, the connection road is a road represented by the high accuracy map data.

### Fifth Modification of Second Embodiment

The travel road determination unit 20 according to the fifth modification of the second embodiment determines that the regular road and the connection road are collectively the general road.

### Third Embodiment

A travel road determination apparatus 101 and a travel road determination method according to the third embodiment will be described. The third embodiment is a subordinate concept of the first embodiment, and the travel road determination apparatus 101 according to the third embodiment includes each configuration of the travel road determination apparatus 100 according to the first embodiment. Note that description of configurations and operations similar to those of the first or second embodiment will be omitted.

In the third embodiment, the road shape data of the high accuracy map data includes slope information indicating a slope of each traffic lane of the freeway. The slope information in the high accuracy map data is, for example, slope data associated with a node located at one end of a traffic lane link. The slope data indicates a slope of the traffic lane link. Similarly, the road shape data of the regular accuracy map data includes slope information indicating a slope of each road of the general road. The slope information in the regular accuracy map data is, for example, slope data associated with a node located at one end of a road link. The slope data indicates a slope of the road link. The slope of the road link or the traffic lane link includes at least one of inclination of the road in its extending direction (front-rear direction) and inclination thereof in a right-left direction that intersects the extending direction.

The freeway according to the third embodiment is an elevated road that extends along the general road and that is provided above the general road. In that case, the connection road for the vehicle to enter the freeway from the general road is inclined upward in the traveling direction of the vehicle. The connection road for the vehicle to enter the general road from the freeway is inclined downward in the traveling direction of the vehicle.

Similarly to the first and second embodiments, the vehicle position acquisition unit 10 acquires the position information of the vehicle. Note that the position information of the vehicle according to the third embodiment includes information of a travel position of the vehicle and information of inclination (angle) of the vehicle at the travel position. The inclination of the vehicle includes at least one of inclination of the vehicle in the front-rear direction and inclination thereof in the right-left direction. The inclination of the vehicle is measured by a sensor provided in the vehicle, for example. In addition, the position information of the vehicle includes the travel route history information being the time series information storing information of such travel positions of the vehicle and inclination of the vehicle.

In the first determination processing, the travel road determination unit 20 determines whether or not the vehicle has started traveling on the connection road, based on the travel route history information included in the second position information and the road shape data of the high accuracy map data. More specifically, the travel road determination unit 20 determines whether or not the vehicle has started traveling on the connection road, based on the time series information of travel positions and inclination of the vehicle in the second position information and the road shape data including a position and slope information of a traffic lane represented by the high accuracy map data.

In the second determination processing, the travel road determination unit 20 determines whether or not the vehicle has started traveling on the freeway, based on the travel route history information included in the fourth position information and the road shape data of the regular accuracy map data. More specifically, the travel road determination unit 20 determines whether or not the vehicle has started traveling on the freeway based on the time series information of travel positions and inclination of the vehicle in the fourth position information and the road shape data including a position and slope information of a road represented by the regular accuracy map data.

Each of these functions of the vehicle position acquisition unit 10 and the travel road determination unit 20 is implemented by the processing circuit illustrated in FIG. 2 or FIG. 3.

The first determination processing when the vehicle arrives at the position P (t12) illustrated in FIG. 14 will be described. As described above, the freeway is an elevated road provided above the general road. Thus, the front part of the vehicle is inclined downward until arrival at the position P (t12). Further, in the high accuracy map data, the slope of the traffic lane link M420 of the exit-dedicated traffic lane is inclined downward in the traveling direction of the vehicle. In contrast, unlike the slope of the exit-dedicated traffic lane, the slope of each of the traffic lane links M701 to M703 of the main lane of the freeway is flat, for example. The travel road determination unit 20 compares the time series information of travel positions and inclination of the vehicle up to the position P (t12) and the road shape data including a position and slope information of the traffic lane link in the high accuracy map data. As a result, the time series information and the information of the traffic lane link M420 of the exit-dedicated traffic lane match each other. Further, the position P (t12) is past the gate G, and the high accuracy map data does not exist, in other words, only the connection road exists. Thus, the travel road determination unit 20 determines that the vehicle has started traveling on the connection road.

The second determination processing when the vehicle arrives at the position P (t2) illustrated in FIG. 12 will be described. The front part of the vehicle is inclined upward until arrival at the position P (t2). Further, in the regular accuracy map data, the slope of the road link L10 of the connection road and the road link L40 of the entrance-dedicated traffic lane of the freeway is inclined upward in the traveling direction of the vehicle. In contrast, unlike the slope of the connection road and the entrance-dedicated traffic lane, the slope of the road link L2 of the regular road is flat, for example. The travel road determination unit 20 compares the time series information of travel positions and inclination of the vehicle up to the position P (t2) and the road shape data including a position and slope information of the road link in the regular accuracy map data. As a result, the time series information matches the information of the road link L10 of the connection road and the road link L40 of the entrance-dedicated traffic lane. Further, the position P (t2) is located in the road link L40 of the entrance-dedicated traffic lane. Thus, the travel road determination unit 20 determines that the vehicle has started traveling on the freeway.

When the freeway is an elevated road that extends along the general road and that is provided above the general road, the position of the freeway and the position of the general road in the map data overlap. Regarding determination of timing when the road type of the road on which the vehicle travels switches, it is extremely difficult to perform the determination by overlapping both of the high accuracy map data and the regular accuracy map data. The travel road determination unit 20 according to the third embodiment determines the road type by using only one piece of map data out of the regular accuracy map data and the high accuracy map data. Further, in this case, the travel road determination unit 20 determines the road type, based on the time series information of travel positions and inclination of the vehicle and the road shape data including a position and slope information of the road in the map data. Thus, the travel road determination apparatus 101 accurately determines the road type also in a section where the freeway and the general road overlap each other. As a result, at the timing when the road type of the road on which the vehicle travels switches, information required by the ADAS and the like is accurately output, allowing for implementation of drive assistance with high accuracy.

### Fourth Embodiment

A travel road determination apparatus 101 and a travel road determination method according to the fourth embodiment will be described. The fourth embodiment is a subordinate concept of the first embodiment, and the travel road determination apparatus 101 according to the fourth embodiment includes each configuration of the travel road determination apparatus 100 according to the first embodiment. Note that description of configurations and operations similar to any one of the first to third embodiments will be omitted.

When the travel road determination unit 20 cannot determine whether or not the vehicle is traveling on the freeway and whether or not the vehicle is traveling on the general road, the travel road determination unit 20 determines that it is a travel road unknown state. For example, when the travel road determination unit 20 cannot determine the road type of the road on which the vehicle is traveling in any one step out of Steps S52, S62, and S72, the travel road determination unit 20 sets the travel road information to unknown. This function of the travel road determination unit 20 according to the fourth embodiment is implemented by the processing circuit illustrated in FIG. 2 or FIG. 3.

When the freeway and the general road extend alongside each other and the connection road is extremely short, determination of the road type using the regular accuracy map data requires time. It is a rare case in which the freeway and the general road extend alongside each other for a long distance. Thus, the travel road determination unit 20 temporarily sets the travel road information to unknown until the travel road determination unit 20 can clearly determine the road type. For example, the travel road determination unit 20 repeats the travel road determination method illustrated in FIG. 8 in a state in which the travel road information is set unknown. The travel road determination unit 20 resumes determination of the road type at the time point when comparing between the position information of the vehicle and the regular accuracy map data or the high accuracy map data is enabled.

### First Modification of Fourth Embodiment

When the travel road determination unit 20 cannot determine the road type of the road on which the vehicle is traveling, the travel road determination unit 20 may calculate probability that the vehicle is traveling on the freeway.

### Second Modification of Fourth Embodiment

When the travel road determination unit 20 becomes unable to compare the position information of the vehicle and the high accuracy map data after determining that the vehicle is traveling on the freeway, the travel road determination unit 20 determines that it is the travel road unknown state. In other words, in the first determination processing, the travel road determination unit 20 determines that the vehicle is in the travel road unknown state.

While the vehicle in the travel road unknown state travels for a predetermined distance after the determination, the travel road determination unit 20 determines the road type based on the position information within the predetermined distance and the high accuracy map data. For example, while the travel road determination unit 20 travels for a predetermined distance of 200 m after the determination, the travel road determination unit 20 determines the road type of the road on which the vehicle is traveling by using the high accuracy map data.

When the position information of the vehicle and the high accuracy map data match, the travel road determination unit 20 determines that the vehicle is traveling on the freeway. In contrast, when the vehicle is still in the travel road unknown state as a result of the determination performed again, the travel road determination unit 20 determines that the vehicle is traveling on the general road.

The travel road unknown state as described above may occur when a section in which the traffic lane is temporarily changed is not reflected in the high accuracy map data because of a construction or the like. In that case, the travel road determination unit 20 determines that the vehicle is traveling on the general road represented by the regular accuracy map data. For example, due to the determination results, execution of advanced drive assistance ends.

### Fifth Embodiment

A travel road determination apparatus 101 and a travel road determination method according to the fifth embodiment will be described. The fifth embodiment is a subordinate concept of the first embodiment, and the travel road determination apparatus 101 according to the fifth embodiment includes each configuration of the travel road determination apparatus 100 according to the first embodiment. Note that description of configurations and operations similar to any one of the first to fourth embodiments will be omitted.

While the vehicle that is determined to be traveling on the freeway through the second determination processing travels for a predetermined distance after the determination, the travel road determination unit 20 determines the road type of the road on which the vehicle is traveling, based on the position information within the predetermined distance and the regular accuracy map data. For example, the travel road determination unit 20 compares the regular accuracy map data and the time series information of travel positions up to the position P (t2), and determines that the vehicle has started traveling on the freeway. Subsequently, while the vehicle travels on the freeway for the predetermined distance, for example, 150 m, determination of the road type is performed using the regular accuracy map data. This function of the travel road determination unit 20 according to the fifth embodiment is implemented by the processing circuit illustrated in FIG. 2 or FIG. 3.

Positioning accuracy of the travel position of the vehicle using the GNSS may become unstable near the gate G provided with a roof. Even in such a case, the travel road determination unit 20 performs determination of the travel position and the road type using the regular accuracy map, and therefore determination accuracy is stabilized. Further, even when the general road and the freeway extend alongside each other near the entrance of the freeway, the travel road determination unit 20 performs the determination as described above, and therefore determination accuracy is stabilized. Note that, when the vehicle enters the general road from the freeway, the travel road determination unit 20 compares the position information of the vehicle and the position of the traffic lane in the high accuracy map data, and thereby determines the road type. Thus, when the vehicle enters the general road from the freeway, the above function is not necessarily required.

### Sixth Embodiment

A travel road determination apparatus and a travel road determination method according to the sixth embodiment will be described. The sixth embodiment is a subordinate concept of the first embodiment, and the travel road determination apparatus according to the sixth embodiment includes each configuration of the travel road determination apparatus 100 according to the first embodiment. Note that description of configurations and operations similar to any one of the first to fifth embodiments will be omitted.

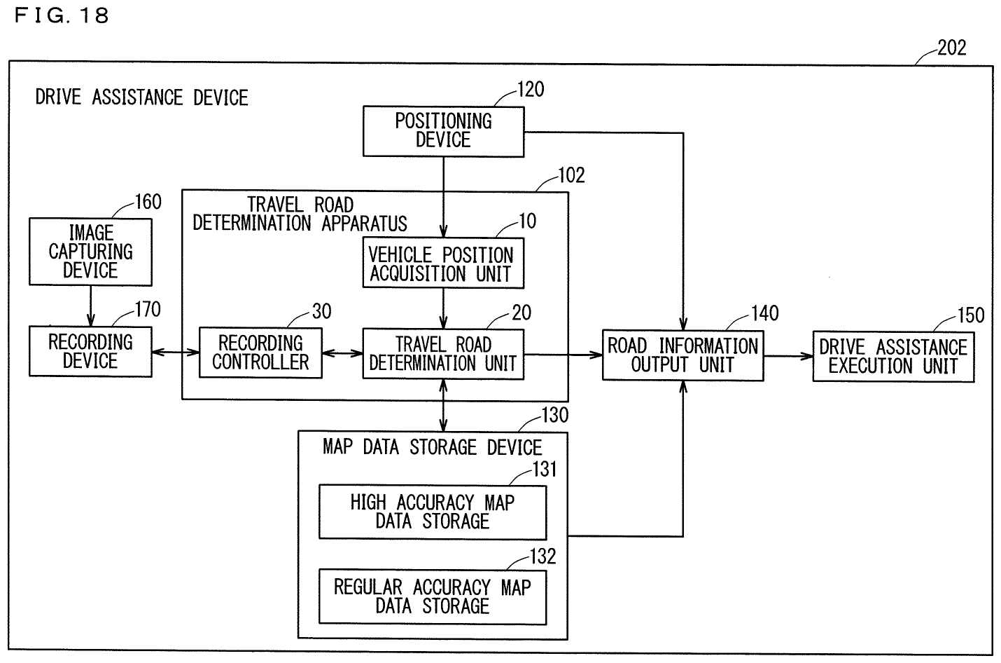

FIG. 18 is a functional block diagram illustrating a configuration of a travel road determination apparatus 102 and a drive assistance device 202 according to the sixth embodiment. The travel road determination apparatus 102 further includes a recording controller 30, in addition to the vehicle position acquisition unit 10 and the travel road determination unit 20 according to the second embodiment. Further, the travel road determination apparatus 102 is connected to a recording device 170.

The recording device 170 stores travel road determination results. The recording device 170 may store an image ahead of the vehicle together with the travel road determination results. The image ahead of the vehicle is captured by an image capturing device 160 installed in the vehicle. The recording device 170 may further store vehicle control information and ADAS control information.

The recording controller 30 records the travel road determination results in the recording device 170. The travel road determination results include determination time, the position information of the vehicle, and the travel road information. Further, the recording controller 30 reads previous travel road determination results from the recording device 170. The previous travel road determination results include, for example, determination results when the vehicle previously traveled from the position P (t0) to the position P (t4) and determination results when the vehicle previously traveled from the position P (t10) to the position P (t13). Alternatively, the previous travel road determination results include results storing determination results when a plurality of vehicles previously traveled from the position P (t0) to the position P (t4) and determination results when a plurality of vehicles previously traveled from the position P (t10) to the position P (t13).

In the first determination processing, the recording controller 30 reads the previous travel road determination results corresponding to the second position information (position P (t12)) of the vehicle from the recording device 170, and outputs the previous travel road determination results to the travel road determination unit 20. The travel road determination unit 20 determines whether or not the vehicle has started traveling on the general road, based on the second position information of the vehicle, the high accuracy map data, and the previous travel road determination results. Similarly, in the second determination processing, the recording controller 30 reads the previous travel road determination results corresponding to the fourth position information of the vehicle from the recording device 170, and outputs the previous travel road determination results to the travel road determination unit 20. The travel road determination unit 20 determines whether or not the vehicle has started traveling on the freeway, based on the fourth position information (position P (t2)) of the vehicle, the regular accuracy map data, and the previous travel road determination results.

With this, determination accuracy of the first determination processing and the second determination processing is enhanced.

### Seventh Embodiment

The travel road determination apparatus described in each of the embodiments above can also be applied to a system constructed by appropriately combining a navigation device, a communication terminal, a server, and functions of applications installed in these. Here, the navigation device includes, for example, a portable navigation device (PND) and the like. The communication terminal includes, for example, a mobile terminal such as a mobile phone, a smartphone, and a tablet.

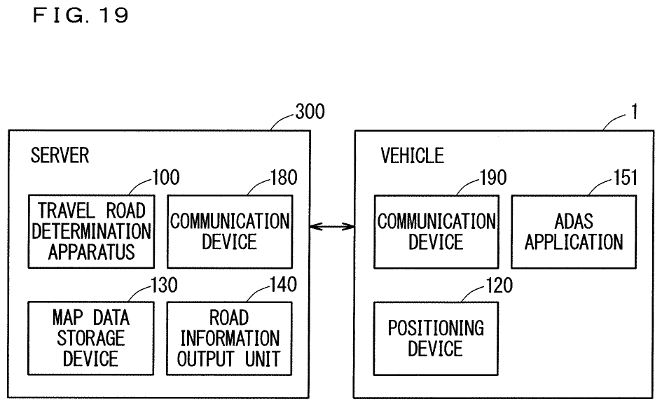

FIG. 19 is a block diagram illustrating a configuration of the travel road determination apparatus 100 and devices operating in association therewith according to the seventh embodiment.

A server 300 is provided with the travel road determination apparatus 100, the road information output unit 140, the map data storage device 130, and a communication device 180. The travel road determination apparatus 100 acquires position information of a vehicle 1 from the positioning device 120 provided in the vehicle 1 via a communication device 190 and the communication device 180. The travel road determination apparatus 100 outputs, to the road information output unit 140, determination results regarding the road type of the road on which the vehicle 1 is traveling. The road information output unit 140 transmits the high accuracy map data to an ADAS application 151 serving as the drive assistance execution unit 150 provided in the vehicle 1 via the communication device 180 and the communication device 190, based on the determination results.

With the travel road determination apparatus 100 being disposed in the server 300 as described above, the configuration of on-board devices can be simplified.

Further, distributed disposition may be implemented, such as in a configuration in which some of the functions and the constituent elements of the travel road determination apparatus 100 are provided in the server 300 and others are provided in the vehicle 1, for example.

Note that, in the present disclosure, each of the embodiments can be freely combined, and each of the embodiments can be modified or omitted as appropriate.

While the disclosure has been shown and described in detail, the foregoing description is in all aspects illustrative and not restrictive. It is therefore understood that numerous unillustrated modifications can be devised.

### EXPLANATION OF REFERENCE SIGNS

1 Vehicle, 10 Vehicle position acquisition unit, 20 Travel road determination unit, 30 Recording controller, 100 Travel road determination apparatus, 101 Travel road determination apparatus, 102 Travel road determination apparatus, 120 Positioning device, 130 Map data storage device, 131 High accuracy map data storage, 132 Regular accuracy map data storage, 140 Road information output unit, 150 Drive assistance execution unit, 151 ADAS application, 160 Image capturing device, 170 Recording device, 201 Drive assistance device, 202 Drive assistance device.

1. A travel road determination apparatus comprising:
a vehicle position acquisition processing circuitry configured to acquire position information of a vehicle; and
a travel road determination processing circuitry configured to perform first determination processing and second determination processing, wherein
in the first determination processing, the travel road determination processing circuitry determines whether or not the vehicle that is determined to be traveling on a first-type road having a road shape represented by first map data including road shape data of each traffic lane based on first position information of the vehicle has started traveling on a second-type road having the road shape represented by second map data including road shape data of each road, based on second position information of the vehicle and the first map data, and
in the second determination processing, the travel road determination processing circuitry determines whether or not the vehicle that is determined to be traveling on the second-type road based on third position information of the vehicle has started traveling on the first-type road, based on fourth position information of the vehicle and the second map data.

2. The travel road determination apparatus according to claim 1, wherein
the second-type road includes a connection road connecting the first-type road and a main lane of the second-type road,
in the first determination processing, the travel road determination processing circuitry determines whether or not the vehicle that is determined to be traveling on the first-type road based on the first position information has started traveling on the connection road, and
in the second determination processing, the travel road determination processing circuitry determines whether or not the vehicle that is determined to be traveling on the connection road based on the third position information has started traveling on the first-type road.

3. The travel road determination apparatus according to claim 1, wherein
the position information of the vehicle includes travel route history information storing a travel position of the vehicle and inclination information of the vehicle at the travel position,
the road shape data of the first map data and the road shape data of the second map data include slope information indicating a slope of the road,
the travel road determination processing circuitry performs the first determination processing, based on the travel route history information included in the second position information and the slope information included in the first map data, and
the travel road determination processing circuitry performs the second determination processing, based on the travel route history information included in the fourth position information and the slope information included in the second map data.

4. The travel road determination apparatus according to claim 1, wherein
the first-type road is an elevated road that extends along the second-type road and that is provided above the second-type road, or a road that extends along the second-type road and that is provided alongside the second-type road.

5. The travel road determination apparatus according to claim 1, wherein
when the travel road determination processing circuitry cannot determine whether or not the vehicle is traveling on the first-type road and whether or not the vehicle is traveling on the second-type road, the travel road determination processing circuitry determines that it is a travel road unknown state.

6. The travel road determination apparatus according to claim 1, wherein
while the vehicle that is determined to be traveling on the first-type road through the second determination processing travels for a predetermined distance after determination, the travel road determination processing circuitry determines a road type of the road on which the vehicle is traveling, based on the position information within the predetermined distance and the second map data.

7. The travel road determination apparatus according to claim 1, wherein
the first-type road includes an advanced drive assistance road in which advanced drive assistance of each of the traffic lane is performed and a non-advanced drive assistance road in which the advanced drive assistance of each of the traffic lane is not performed.

8. The travel road determination apparatus according to claim 5, wherein
while the vehicle that is determined to be in the travel road unknown state through the first determination processing travels for a predetermined distance after determination, the travel road determination processing circuitry performs determination of a road type of the road on which the vehicle travels, based on the position information within the predetermined distance and the first map data, and
when the vehicle is in the travel road unknown state as a result of the determination in the predetermined distance, the travel road determination processing circuitry determines that the vehicle is traveling on the second-type road.

9. The travel road determination apparatus according to claim 1, further comprising
a recording controller configured to perform control of recording travel road determination results by the travel road determination processing circuitry in a recording device storing the travel road determination results.

10. A travel road determination method comprising:
acquiring position information of a vehicle;
as first determination processing, when the vehicle is determined to be traveling on a first-type road having a road shape represented by first map data including road shape data of each traffic lane based on first position information of the vehicle, determining whether or not the vehicle has started traveling on a second-type road having the road shape represented by second map data including road shape data of each road, based on second position information of the vehicle and the first map data; and
as second determination processing, when the vehicle is determined to be traveling on the second-type road based on third position information of the vehicle, determining whether or not the vehicle has started traveling on the first-type road, based on fourth position information of the vehicle and the second map data.
